(19) United States
(12) Patent Application Publication
(10) Pub. No.: US 2009/0203294 A1
(43) Pub. Date: Aug. 13, 2009

(54) Motor skills development toy device

(76) Inventor: Jessica Kessin, San Francisco, CA (US)

Correspondence Address: FELDMAN LAW GROUP, 12 East 41st Street, New York, NY, 10017, US

(21) Appl. No.: 12/069,325

(22) Filed: Feb. 9, 2008

(51) Int. Cl. A63H 33/00; G09B 19/00

(52) U.S. Cl. 446/486; 434/258

(57) ABSTRACT

A fine motor skills development toy device is described that has a ring member which stores a plurality of granular materials such as beads. The toy device also has a knob section, a button section, a cuff section, a handle section, and a key section which may operate between a first and a second position to facilitate pulling, squeezing, rotating, spinning, and turning actions that improve motor skills of the hands of the child.

### FIELD OF THE INVENTION

The present invention relates to toys and, more particularly, to a toy that promotes motor skills development in the children.

### DESCRIPTION OF RELATED ART

The prior art references include operating means to develop motor skills. The ways, however, in which the prior art develop motor skills in children are complex, not stimulating, and/or overbearing. Thus, a motor skills development toy device is needed which is simplified, easy to use, and adapted to boost the learning interest of the child.

### SUMMARY OF THE INVENTION

A motor skills development toy device is described that comprises a tubular member that has a hollow interior adapted to accommodate a plurality of granular materials, preferably beads that are movable along an inner surface of the ring member. The member, preferably a ring, comprises a knob section, a button section, a cuff section, a handle section, and a key section that facilitate pulling, squeezing, rotating, spinning, and turning actions that are operated as to develop fine motor skills of entire hand of a child. The knob section, the button section, and the cuff section, each respectively include a door portion that defines a first position and a second position for each section. The first position of each section, in its resting state, facilitates the door portion to block the inner surface of the ring member to prevent the beads from passing through the respective section. The second position of each section, when activated, facilitates the door portion to unblock the inner surface of the ring member to allow the beads to pass through the section. When turned, the handle section and the key section can be spinned from the resting position in either a counter clockwise or a clockwise direction, which allows the beads to be pushed through the tube.

### BRIEF DESCRIPTION OF DRAWINGS

The above mentioned and other features, aspects and advantages of the present invention will become better understood with regard to following description, appended claims and accompanying drawings, wherein like reference numerals refer to similar parts throughout the several views where:

FIG. 1 is a top perspective view of a fine motor skills development toy device constructed in accordance with the present invention;

FIG. 2 is an exploded view of a portion of a knob section of the toy device of FIG. 1;

FIG. 3 is an enlarged view of the portion of the knob section of the toy device of FIG. 1;

FIG. 4 is an enlarged view of a portion of a button section of the toy device of FIG. 1;

FIG. 5 is an enlarged view of the portion of the button section of the toy device of FIG. 1;

FIG. 6 is an enlarged view of a portion of a cuff section of the toy device of FIG. 1;

FIG. 7 is an enlarged view of the portion of the cuff section of the toy device of FIG. 1;

FIGS. 8-9 are enlarged views of a portion of a handle section of the toy device of FIG. 1; and

FIGS. 10-11 are enlarged views of a portion of a key section of the toy device of FIG. 1;

### DETAILED DESCRIPTION OF THE INVENTION

Although specific terms are used in the following description for sake of clarity, these terms are intended to refer only to particular structure of the invention selected for illustration in the drawings, and are not intended to define or limit the scope of the invention.

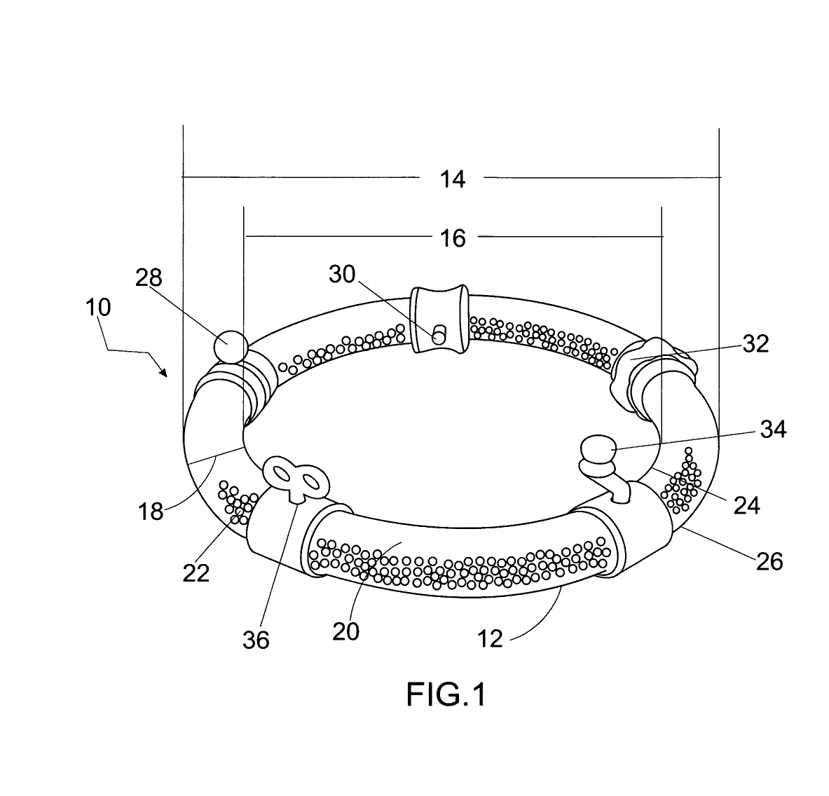

Referring initially to FIG. 1, a fine motor skills development toy device 10 is shown that includes a tubular ring member 12 bilaterally disposed along a central axis-X. The ring member 12 that has an outer diameter 14 and an inner diameter 16 adapted to define a radial thickness 18. The member may be, but not limited to, a ring, cube shaped, an S Shape, a long tube or any other combination of these components for a similar purpose. The inner diameter 16 defines a hollow interior 20 that accommodates a plurality of colored granular material, preferably beads 22. The beads 22, in this one preferred embodiment, are movable along an inner surface 24 defined by the inner diameter 16 of ring 12. The member 12 is preferably made of transparent plastic material. It is understood, however, that the device can be made of other food grade standard, non-toxic transparent plastics such as a thermoplastic polyether-ester elastomer and the like.

The ring member 12 includes a plurality of sections that are equidistantly incorporated on an outer surface 26 defined by outer diameter 14 of ring 12. In this preferred embodiment, the ring member 12 includes five sections namely a knob section 28, a button section 30, a cuff section 32, a handle section 34, and a key section 36 that are preferably fitted over ring 12. The sections 28, 30, 32, 34 and 36 are preferably adapted to respectively teach different mechanical actions to the children such as pulling, squeezing, rotating, spinning and turning.

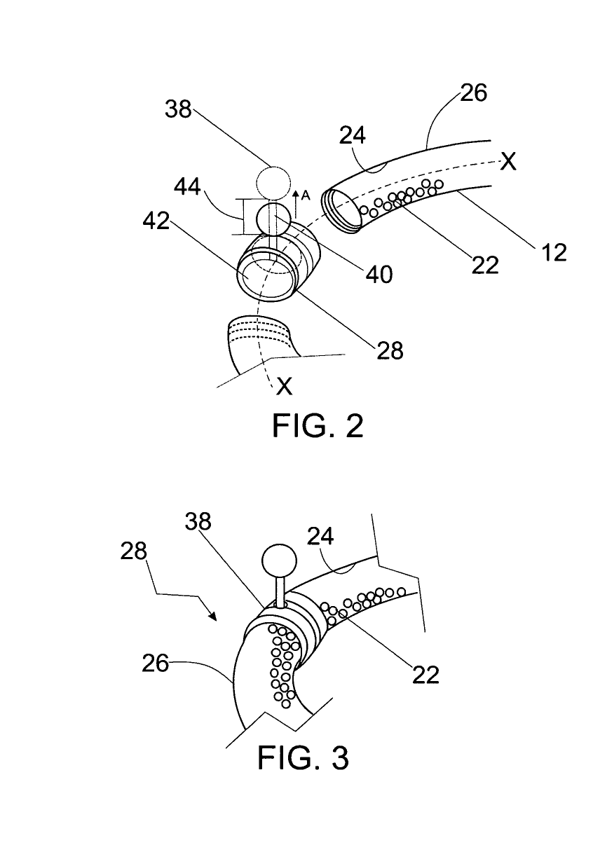

Referring to FIG. 2, knob section 28 includes a knob 38, a connecting flange 40, and a door portion 42. The knob 38 is a circular protuberance that has a configuration adapted to be comfortably grasped. The flange 40 has a top end that connects to knob 38. The flange 40 has a bottom end that connects to door 42. The knob 38 preferably remains in the proximity to outer surface 26 of the ring member 12 so as to define a first position. In the first position, in its resting state, the knob 38 allows door 42 to block the inner surface 24 of the ring member 12 so as to prevent the beads 22 to pass through knob section 28. The knob 38 can be pulled from the first position up to a predetermined distance 44 of flange 40 in the direction indicated by a directional arrow A, so as define a second position of the knob 38.

Referring to FIG. 3, knob 38 is in the second position. In the second position, when activated, knob 38 allows door 42 to unblock inner surface 24 so as to allow the beads 22 to pass through knob section 28. The flow of beads 22 in the second position can stimulate the curiosity of the child. The child may try to perform repetitive pulling activity which can improve the motor skills of the hand of the child.

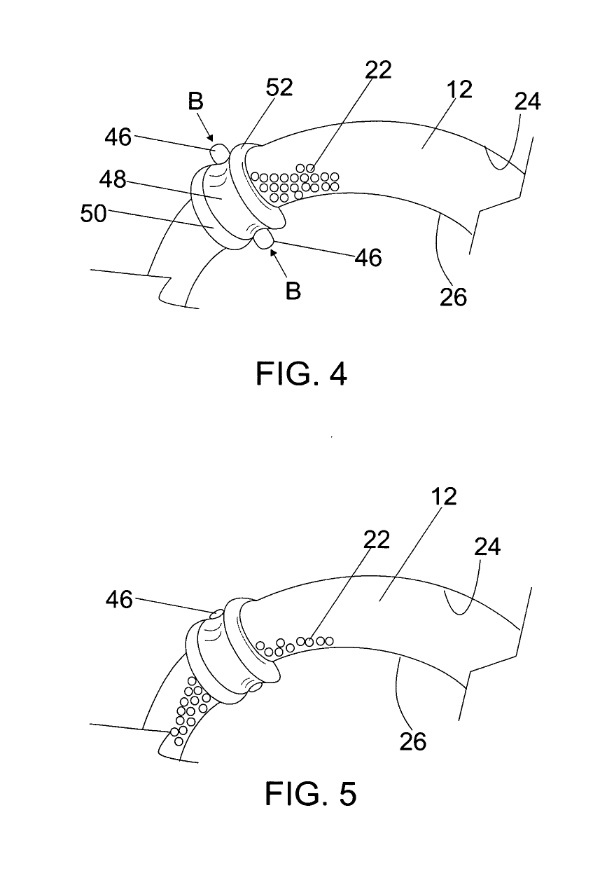

Referring to FIG. 4, button section 30 includes a pair of squeezing tabs 46 that are radially spaced apart along the central axis. The button section 30 has a concave shaped body 48 that defines a concave interior within the button section 30. The body 48 has a first end 50 and a second end 52 that preferably protrude from the body 48 so as to be connected to the ring member 12. The ends 50, 52 preferably have diameters that are substantially equal to the diameter of the ring member 12. The button section 30 includes similar door portion 42 as that of knob section 28 placed within interior 20 that is interconnected to tabs 46 such that the motion of door 42 substantially depends on the motion of the tabs 46. In this one preferred embodiment, tabs 46 have a configuration adapted to be squeezed. Tabs 46 define a first position before being squeezed. In the first position, in their resting state, tabs 46 allow the door 42 to block the inner surface 24 of the ring member 12 so as to prevent the beads 22 to pass through button section 30. The tabs 46 can be squeezed from the first position up to a predetermined distance in the direction indicated by the directional arrows B, so as define a second position of the tabs 46.

Referring to FIG. 5, the tabs 46 are in the second position. In the second position, when activated, tabs 46 allow door 42 to unblock inner surface 24 so as to allow the beads 22 to pass through button section 30. The flow of beads 22 in the second position can stimulate the curiosity of the child. The child may also try to perform repetitive squeezing activity which can improve motor skills of the hand of the child.

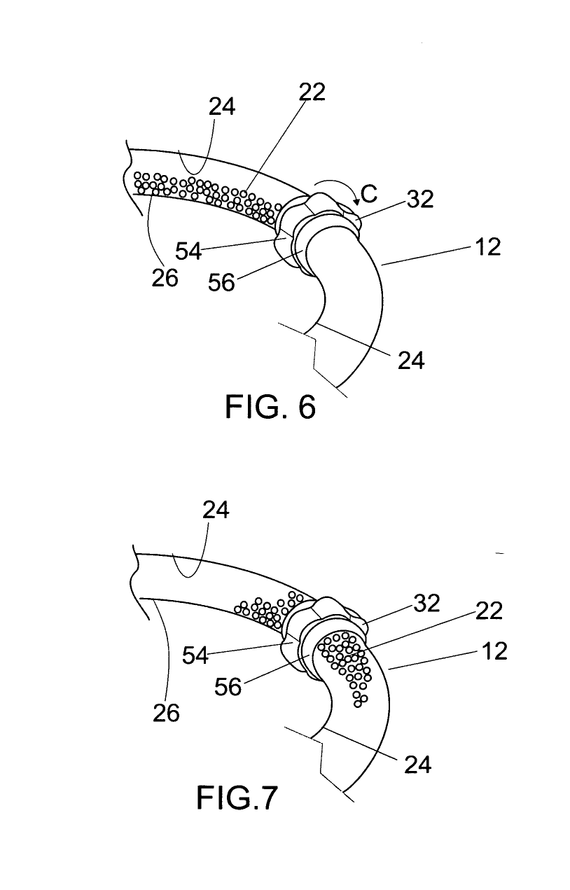

Referring to FIG. 6, cuff section 32 includes a rotor wheel 54 and a sleeve member 56. The sleeve member 56 has a cylindrical shape and is preferably adapted to be fitted over the ring member 12. The sleeve 56 has an inner diameter and an outer diameter that define the thickness of sleeve 56. In this one embodiment, the thickness of the sleeve is substantially equal to the thickness of the ring member 12. It is, however, understood that the thickness of the ring member 12 may vary in other alternative embodiments. The sleeve 56 preferably has a configuration that is substantially twice the configuration of the rotor wheel 54. The sleeve member 56 encloses the ring member 12 and preferably connects to the rotor wheel 54 such that the wheel 54 is rotatable over the sleeve 56. The cuff section 32 includes similar door portion 42 as that of knob section 28 and is placed within interior 20 that is interconnected to rotor wheel 54 such that the motion of door 42 substantially depends on the motion of the wheel 54.

The cuff section 32 includes similar door portion 42 as that of knob section 28 placed within interior 20 that is interconnected to rotor wheel 54 such that the motion of door 42 substantially depends on the motion of the rotor wheel 54. In this preferred embodiment, rotor wheel 54 has a helical configuration that is preferably adapted to be rotated using at least few fingers of the hand of the child. Rotor wheel 54 defines a first position before being rotated. In the first position, in its resting state, wheel 54 allows the door 42 to block the inner surface 24 of the ring member 12 so as to prevent the beads 22 to pass through cuff section 32. The wheel 54 can be rotated from the first position up to a predetermined distance in a clockwise direction indicated by the directional arrows C, so as define a second position of the wheel 54.

Referring to FIG. 7, rotor wheel 54 is in the second position. In the second position, when activated, rotor wheel 54 allows door 42 to unblock inner surface 24 so as to allow the beads 22 to pass through cuff section 32. The flow of beads 22 in the second position can stimulate the curiosity of the child. The child may also try to perform repetitive rotating activity of wheel 54, which indirectly improves motor skills of the hand of the child.

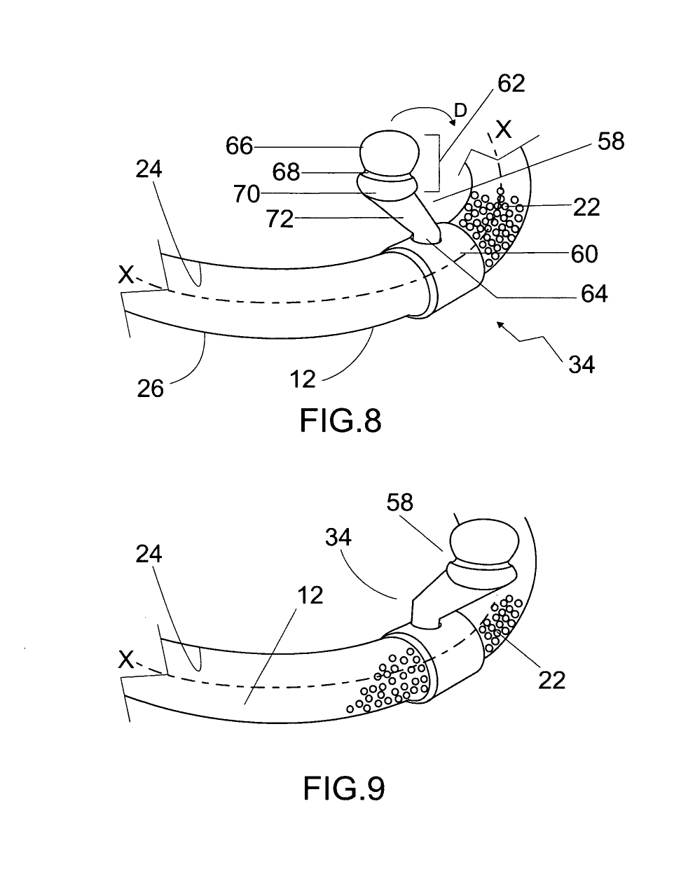

Referring to FIGS. 8-9, handle section 34 includes a handle portion 58 and a sleeve portion 60. The handle portion 58 has a gripping end 62 and a pivoted end 64. The gripping end 62 includes a knob 66, an indentation 68 and a protrusion 70. The protrusion 70 has a diameter that is preferably equal to a diameter defined by the knob 66. The protrusion 70 is connected to the knob 66 through indentation 68. The handle portion 58 includes a connecting arm 72 that connects the pivoted end 64 to protrusion 70. The connecting arm 72 preferably downwardly tapers from protrusion 70 up to pivoted end 64. The knob 66 has a configuration that is adapted to be comfortably grasped. The sleeve portion 60 has a cylindrical shape and is preferably adapted to be fitted over the ring member 12. The sleeve portion 60 has an inner diameter and an outer diameter that define the thickness of sleeve portion 60. In this one embodiment, the thickness of the sleeve portion 60 is substantially equal to the thickness of the ring member 12. The sleeve portion 60 encloses ring member 12 and preferably connects to pivoted end 64 such that handle portion 58 can be spinned on to sleeve portion 60. The handle section 34 includes similar door portion 42 as that of knob section 28 within interior 20 that is interconnected to pivoted end 64 such that the motion of door 42 substantially depends on the motion of handle portion 58. In this one preferred embodiment, handle portion 58 has a configuration adapted to be spun. The handle portion 58 preferably remains perpendicular to the central axis-X so as to define a position of the handle section 34. In its resting state, handle portion 58 allows the door 42 to block the inner surface 24 of the ring member 12 so as to prevent the beads 22 to pass through handle section 34. When turned, the handle portion 58 can be spun from the position in either a counter clockwise or a clockwise direction, which allows the beads to be pushed through the tube. The beads will be pushed through as long as the child keeps turning handle portion 58.

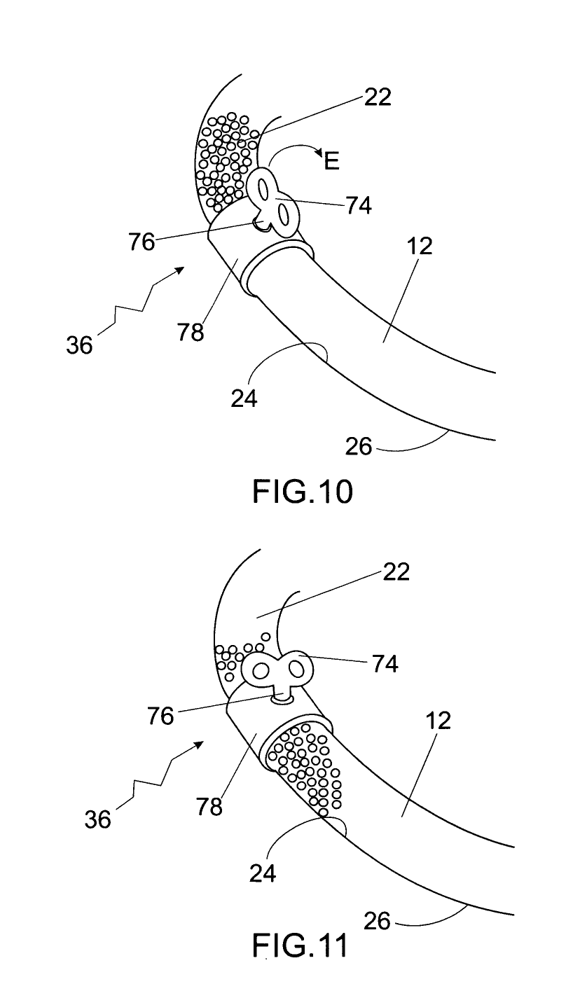

Referring to FIGS. 10-11, key section 36 includes a gripping portion 74, a connecting portion 76 and a sleeve portion 78. The gripping portion 74 preferably includes a pair of identical holes that preferably has a configuration adapted to be grasped. The sleeve portion 78 has a cylindrical shape and is preferably adapted to be fitted over the ring member 12. The sleeve portion 78 has an inner diameter and an outer diameter that define the thickness of sleeve portion 78. In this one embodiment, the thickness of the sleeve portion 78 is preferably equal to the thickness of the ring member 12. The sleeve portion 78 encloses ring member 12 and preferably connects to connecting portion 76 such that gripping portion 74 can be turned on to sleeve portion 78. The key section 36 includes similar door portion 42 as that of knob section 28 within interior 20 that is interconnected to connecting portion 76 such that the motion of door 42 substantially depends on the motion of gripping portion 74. The gripping portion 74 preferably remains parallel to the central axis-X so as to define a position of the key section 36. In its resting state position, gripping portion 74 allows the door 42 to block the inner surface 24 of the ring member 12 so as to prevent the beads 22 to pass through handle section 34. When turned, the gripping portion 74 can be spun from the resting position in either a counter clockwise or a clockwise direction, which allows the beads to be pushed through the tube. The beads will be pushed through as long as the child keeps turning gripping portion 74.

In the preceding specification, the invention has been described with reference to specific exemplary embodiments thereof. It will be evident, however, that various modifications, combinations and changes may be made thereto without departing from the broader spirit and scope of the invention as set forth in the claims that follow. It is understood that the present invention can combine one or more novel features of the different embodiments. The specification and drawings are accordingly to be regarded in an illustrative manner rather than a restrictive sense.

What is claimed is:

1. A motor skills development toy device comprising:
a tubular member that has a hollow interior adapted to accommodate a plurality of granular materials, the granular materials are movable along an inner surface of the ring member, the ring member comprising a knob section, a button section, a cuff section, a handle section, and a key section that facilitate pulling, squeezing, rotating, spinning and turning actions that together develop motor skills.

2. The device of claim 1, wherein the member is a ring.

3. The device of claim 1, wherein the granular materials are beads.

4. The device of claim 1, wherein the knob section, the button section, the cuff section, the handle section, and the key section each respectively include a door portion within the member.

5. The device of claim 1, wherein the member is cube shaped.

6. The device of claim 1, wherein the member is an S Shape.

7. The device of claim 1, wherein the member is a long tube.
